(19) United States
(12) Patent Application Publication
(10) Pub. No.: US 2006/0190958 A1
(43) Pub. Date: Aug. 24, 2006

(54) Optical recording medium

(75) Inventors: Yoshiyuki Nagataki, Osaka (JP); Hironori Ota, Osaka (JP)

Correspondence Address: OLIFF & BERRIDGE, PLC, P.O. BOX 19928, ALEXANDRIA, VA, 22320, US

(73) Assignee: HITACHI MAXELL, LTD., Osaka (JP)

(21) Appl. No.: 11/357,103

(22) Filed: Feb. 21, 2006

(30) Foreign Application Priority Data
Feb. 24, 2005 (JP) 2005-049528

(51) Int. Cl. G11B 7/24; G11B 23/03

(52) U.S. Cl. 720/718

(57) ABSTRACT

An optical recording medium including two recording layers, each containing an organic dye includes: a first disk substrate formed by laminating a first recording layer and a translucent intermediate layer sequentially on a first transparent substrate made of polycarbonate or the like; and a second disk substrate formed by laminating a reflective layer, a second recording layer, and an interface layer sequentially on a second substrate. The first and the second disk substrates are laminated with a transparent adhesive layer interposed therebetween in a manner that the translucent intermediate layer faces the interface layer. A reflectivity (R₁) at a portion of a recording mark formed on any of the first and the second recording layers becomes higher than a reflectivity (R₀) at a portion on the recording layer where the recording mark is not formed (R₁>R₀).

### BACKGROUND OF THE INVENTION

1. Field of the Invention

The present invention relates to an optical recording medium, and more specifically, to an optical recording medium including a plurality of recording layers, each containing an organic dye.

2. Description of the Related Art

In recent years, there have been significant demands for an increase in the capacity of optical recording media (such as an optical disk) along with developments of information communication equipment. A reduction in the wavelength of recording and reproducing light, an increase in the NA (numerical aperture) of a lens in an optical system, a reduction in a width of a track pitch, land and groove recording on recording tracks, multilayer structuring of recording layers, and other attempts have been actively explored to increase the capacity of an optical disk. In particular, the multilayer structuring of the recording layers facilitates an increase in an area of the recording layers without changing dimensions of the disk. Moreover, the multilayer structuring has advantages of dispensability in terms of development of an object lens associated with the increase in the NA of the lens in an optical system, production techniques to suppress a surface runout, a cartridge for ensuring an antifouling property, and the like.

Here, a method of forming a two-layered recording layer includes a 2P method and an inverted stack method. The 2P method is a method including steps of: coating photo curable resin on a first recording layer and on a translucent intermediate layer which are formed on a substrate on the light incident side; pressing a light-transmissive stamper thereon; transferring a groove pattern by peeling the light-transmissive stamper off after curing the photocurable resin by light irradiation; and forming a second recording layer on the groove pattern (see Japanese Unexamined Patent Publication No. 2003-331463).

A two-layered optical disk manufactured by the above-described 2P method has a configuration of laminating single-layered disk structures. Therefore, it is relatively easy for the two-layered optical disk to obtain recording and reproduction characteristics similar to a single-layered disk except for a problem of a recording sensitivity. However, recycling of the light-transmissive stamper is difficult in addition to complexity of manufacturing the two-layered optical disk, accordingly there is a problem of a high manufacturing cost.

On the other hand, the inverted stack method is a method of manufacturing the two-layered optical disk by attaching a first substrate having a first recording layer formed thereon to a second substrate having a second recording layer formed thereon by use of transparent adhesive (see Japanese Unexamined Patent Publication No. 2003-331473).

The two-layered optical disk manufactured by the inverted stack method has an advantage of lower manufacturing costs as compared to the 2P method. However, the structure of a recording layer and a reflective layer on the back side viewed from a laser incident side is reversed in comparison with the single-layered disk. Accordingly, this optical disk has a problem of a difficulty to optimize recording and reproduction characteristics.

To solve this problem, for example, there has been reported a method of obtaining favorable reproduction and recording signals from a second recording layer of a two-layered optical disk manufactured by the inverted stack method by means of forming the second recording layer having a film thickness larger than a film thickness of the first recording layer (see Japanese Unexamined Patent Publication No. 2004-348880).

Incidentally, advancement of reduction in the wavelength of the recording and reproducing light in order to attain the increase in the capacity of the optical disk is promoted, the following problem occurs. Specifically, in the two-layered optical disk, for example, it is necessary to record on both of the two recording layers. Accordingly, more than a half amount of light incident from the first substrate on one side passes through the first recording layer and the translucent intermediate layer. In other words, sensitivity of the two-layered optical disk is extremely lower than that of the single-layered optical disk including only one recording layer. For this reason, a high-output laser is required to record on the recording layers of the two-layered optical disk. Conventionally, a commercially available DVD+R manufactured by the 2P method applies a red laser having a wavelength of approximately 650 nm and a high output equal to or above 150 mW. Therefore, it is possible to realize the two-layered optical disk even when the sensitivity of the recording layers is not very high. On the contrary, a blue laser used in recent years for the purpose of increasing the capacity of the optical disk has a difficulty to ensure a high output unlike the red laser.

Meanwhile, in a conventional CD-R or DVD-R, recording marks are formed by exploding an organic dye with light irradiated on a recording layer and thereby deforming a substrate. In the recording layer containing the organic dye, a portion where the recording mark is formed as described above has a lower reflectivity than a portion (a space) where the recording mark is not formed (referred to as “High to Low recording”). In this recording method, it is possible to improve a reflectivity of an unrecorded portion on the recording layer. Accordingly, this method has an advantage of ease of achieving compatibility with a ROM disk in terms of the recording and reproduction characteristics. On the contrary, the method has a problem of low recording sensitivity due to small light absorption at an unrecorded portion.

### SUMMARY OF THE INVENTION

The present invention has been made to solve the foregoing problems.

Specifically, an object of the present invention is to provide a multilayer type optical recording medium in which information is recorded and reproduced by use of recording and reproducing light having a short wavelength, in an optical recording medium including a plurality of recording layers, in which information is recorded and reproduced by light irradiation, and each of which contains an organic dye.

To solve the foregoing problems, in the present invention, recording layers are formed by use of an organic dye having a specific property.

Specifically, the present invention provides an optical recording medium including at least two recording layers, each of which contains an organic dye, and in which information is recorded and reproduced by light irradiation. Here, a reflectivity (R₁) at a portion of a recording mark formed on any of the recording layers becomes higher than a reflectivity (R₀) at a portion on the recording layer where the recording mark is not formed (R₁>R₀).

The multilayer optical recording medium adopting the present invention applies “Low to High recording” in which the reflectivity at the portion of the recording mark becomes higher than the reflectivity in a space where the recording mark is not formed. In this way, it is possible to increase light absorption of the recording layer in an unrecorded state so as to absorb more energy of a laser beam, and thereby it is possible to improve recording sensitivity.

Here, a difference (R₁−R₀) between the reflectivity (R₁) at the portion of the recording mark and the reflectivity (R₀) at the portion where the recording mark is not formed is preferably set to at least 2%.

Moreover, the plurality of recording layers preferably contain the organic dye having an extinction coefficient (k) of at least 0.1 relative to light having a wavelength in a range from 390 nm to 420 nm.

A degree of modulation of a reproduced signal obtained from the recording marks formed on the plurality of recording layers containing the organic dye having the above-described property is at least 40%.

Moreover, the light used for recording and reproduction of the optical recording medium adopting the present invention is preferably irradiated from one side of the optical recording medium.

Next, the present invention provides an optical recording medium having two recording layers each containing an organic dye, which includes: a first disk substrate formed by sequentially laminating a first recording layer and a translucent intermediate layer on a first substrate made of a light-transmissive material; and a second disk substrate formed by laminating a reflective layer, a second recording layer, and an interface layer on a second substrate. Here, the first and the second disk substrates are laminated with a transparent adhesive layer interposed therebetween in a manner that the translucent intermediate layer faces the interface layer. Moreover, the reflectivity (R₁) at a portion of a recording mark formed on any of the first and second recording layers by light irradiated becomes higher than the reflectivity (R₀) at a portion on the recording layer where the recording mark is not formed (R₁>R₀).

That is, the first substrate, on which the first recording layer is formed, and the second substrate, on which the second recording layer is formed, are attached with the transparent adhesive layer interposed therebetween, thereby the optical recording medium adopting the present invention can be manufactured at low costs.

Here, a groove depth of a groove formed on the first substrate preferably has a dimension at least twice as large as a groove depth of a groove formed on the second substrate.

Moreover, a track pitch of the grooves formed on the first and the second substrates is preferably set in a range from 390 nm to 410 nm.

Furthermore, the light for recording and reproduction is preferably irradiated from the first substrate, and information is preferably recorded on the first recording layer located in front and on the second recording layer located in the back when viewed from the light incident side.

Meanwhile, in the two-layered optical recording medium adopting the present invention, the recording marks are preferably formed at a portion on the first recording layer exiting at a concave portion on a front side of the first substrate and at a portion on the second recording layer existing at a concave portion on a back side of the second substrate when viewed from the first substrate's side, on which the light is irradiated.

In this case, the light used for recording and reproduction preferably has a wavelength in a range from 390 nm to 420 nm.

Furthermore, the organic dye contained in the recording layers is preferably a monomethine-azo metal complex dye.

According to the present invention, it is possible to record information on a multilayer optical recording medium including a plurality of recording layers that contain an organic dye by use of recording and reproducing light having a short wavelength.

### BRIEF DESCRIPTION OF THE DRAWINGS

FIG. 1 is a view to explain a layer structure of an optical recording medium to which the present embodiment is applied.

### DESCRIPTION OF THE PREFERRED EMBODIMENT

Now, the best mode (an embodiment) for carrying out the present invention will be described with reference to the accompanying drawing. It is to be noted that the present invention is not limited only to the following embodiment, and various modifications are possible without departing from the scope of the invention. In addition, the accompanying drawing is used solely for the purpose of explaining the embodiment and does not necessarily reflect actual sizes or dimensions.

(Optical Recording Medium)

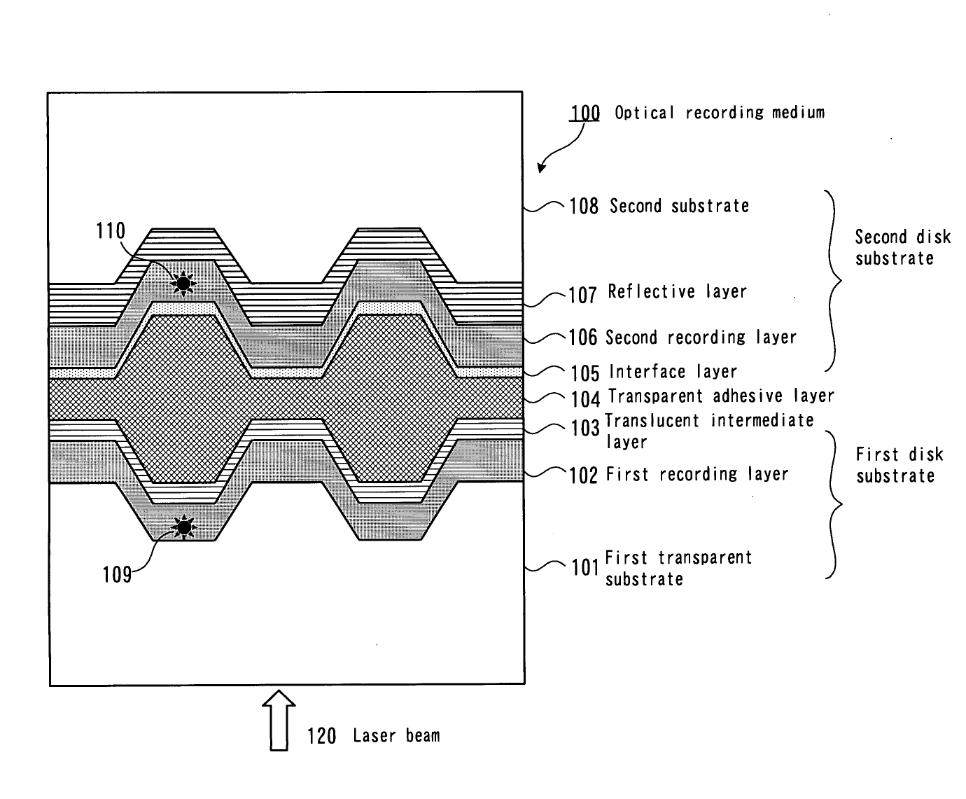

FIG. 1 is a view for explaining a layer structure of an optical recording medium adopting an embodiment of the present invention. An optical recording medium 100 shown in FIG. 1 includes: a disk-shaped first transparent substrate 101 having track guide grooves; a first recording layer 102 containing a dye and being laminated on the first transparent substrate 101; and a translucent intermediate layer 103 for spreading power of a laser beam 120, which is incident from the first transparent substrate 101 side (a first disk substrate). Subsequently, the optical recording medium 100 further includes: a disk-shaped second substrate 108 having track guide grooves; a reflective layer 107 laminated on the second substrate 108; a second recording layer 106 containing a dye; and an interface layer 105 (a second disk substrate).

As shown in FIG. 1, the optical recording medium 100 has a structure, in which the first disk substrate is attached to the second disk substrate with a transparent adhesive layer 104 interposed therebetween in a manner that the translucent intermediate layer 103 laminated on the first transparent substrate 101 faces the interface layer 105 laminated on the second substrate 108.

The laser beam 120 having a wavelength in a range from 390 nm to 420 nm is incident on the optical recording medium 100 from one side thereof. Accordingly, recording marks are formed on the first recording layer 102 located in front and on the second recording layer 106 located in the back when viewed from the light incident side, and information is thereby recorded and reproduced. In this embodiment, a position where the recording mark is formed on the first recording layer 102 of the optical recording medium 100 is preferably located at a portion of a concave groove 109 of the first recording layer, which is a concave portion on a front side defined by the track guide grooves formed on the first transparent substrate 101 when viewed from the incident side of the laser beam 120. Meanwhile, a position where the recording mark is formed on the second recording layer 106 is preferably located at a portion of a concave groove 110 of the second recording layer 106, which is a concave portion on a back side defined by the track guide grooves formed on the second substrate 108 when viewed from the incident side of the laser beam 120.

In the optical recording medium 100 adopting this embodiment, by the laser beam 120 thus irradiated, a reflectivity (R₁) at a portion of the recording mark formed on the first recording layer 102 or the second recording layer 106 becomes higher than a reflectivity (R₀) at a portion where the recording mark is not formed (R₁>R₀) (Low to High recording). Now, the respective layers will be described.

(Recording Layers)

The two recording layers (the first recording layer 102 and the second recording layer 106) in the optical recording medium 100 adopting this embodiment contain an organic dye suitable for recording information by use of the light having the wavelength in the range from 390 nm to 420 nm. For example, the organic dye to be used in the first recording layer 102 or the second recording layer 106 may include: a polymethine dye such as a cyanine dye, a merocyanine dye or a squalirium dye; a macrocyclic azaannulene dye such as a phthalocyanine dye or a porphyrin dye; an anthraquinone dye; a triarylmethane dye; a pyrilium dye; an azo dye; a metal-containing azo dye; triarylamine dye; a pyrromethene dye; a formazan metal complex dye; monomethine-azo metal complex dye; an annulene dye; and the like. However, the organic dye is not limited only to the foregoing.

It is possible to use one of the organic dyes mentioned above or a combination of two or more kinds of the organic dyes. Moreover, the two recording layers may further contain a quencher, a dye other than the foregoing, an additive, a polymer (thermoplastic resin such as nitrocellulose, and thermoplastic elastomer, for example), metal particles, and the like.

The two recording layers (the first recording layer 102 and the second recording layer 106) in the optical recording medium 100 adopting this embodiment preferably contain the organic dye having a high optical absorption property. To be more precise, an extinction coefficient (k) of an optical constant of the organic dye contained in the two recording layers (the first recording layer 102 and the second recording layer 106) relative to the light incident from the first transparent substrate 101 side and having the wavelength in the range from 390 nm to 420 nm is set equal to or above 0.1, or more preferably, equal to or above 0.15. It is to be noted, however, the extinction coefficient (k) is set usually equal to or below 0.3, or preferably equal to or below 0.25.

The two recording layers (the first recording layer 102 and the second recording layer 106) in the optical recording medium 100 contain the organic dye having the extinction coefficient (k) in the above-mentioned range relative to the light having the wavelength in the range from 390 nm to 420 nm, thereby it is possible to perform the recording (Low to High recording) in which the reflectivity (R₁) at the portion of the recording mark formed by the irradiated light becomes higher than the reflectivity (R₀) at the portion where the recording mark is not formed (R₁>R₀).

To be more precise, it is possible to set a difference (R₁−R₀) between the reflectivity (R₁) at the portion of the recording mark formed on the first recording layer 102 or the second recording layer 106 and the reflectivity (R₀) at the portion where the recording mark is not formed to equal to or above 2% or preferably equal to or above 5%. When the difference (R₁−R₀) is set to at least 2%, it is possible to obtain a degree of modulation of at least 40% out of a reproduced signal to be obtained from the recording mark.

Here, the reflectivity (R₁) at the portion of the recording mark formed on the first recording layer 102 or the second recording layer 106 is set usually in a range from 6% to 10% or preferably in a range from 6.5% to 8%. Meanwhile, the reflectivity (R₀) at the portion where the recording mark is not formed on the first recording layer 102 or the second recording layer 106 is set usually in a range from 2% to 5% or preferably in a range from 3% to 4%.

The optical recording medium 100 adopting this embodiment performs the recording (Low to High recording) in which the reflectivity (R₁) at the portion of the recording mark formed on the recording layer becomes higher than the reflectivity (R₀) at the portion where the recording mark is not formed (R₁>R₀), thereby it is possible to increase a light absorption at the portion on the recording layer where the recording mark is not formed, to allow that portion to absorb more energy of the laser beam 120, and to improve recording sensitivity. As a result, it is possible to perform recording and reproduction of information favorably by use of a blue laser, which is used for the purpose of increasing the capacity of the optical disk.

As the method of forming the first recording layer 102 and the second recording layer 106, a method of coating an organic dye solution on the respective substrates by use of the spin coating method can be cited. The organic dye solution is usually prepared by dissolving or solvating the above-mentioned organic dye and other additives that are added as appropriate into a publicly-known organic solvent (such as tetrafluoropropanol, ketone alcohol, acetylacetone, methyl cellosolve or toluene). As for conditions in the spin coating method, spin coating may be carried out from an inner periphery to an outer periphery of the substrate in combination with several patterns of revolutions set in a range from 300 rpm to 5000 rpm. The respective thicknesses of the first recording layer 102 and the second recording layer 106 may be appropriately selected depending on conditions including the spin coating revolutions, concentration and viscosity of the organic dye solution, a drying rate of the solvent, and the like. The thicknesses are not particularly limited. However, usually, each of the recording layers is preferably formed in a range approximately from 60 nm to 120 nm in thickness in terms of a groove and in a range approximately from 40 nm to 80 nm in thickness in terms of a land.

It should be noted that the organic dye contained in the two recording layers (the first recording layer 102 and the second recording layer 106) of the optical recording medium 100 adopting this embodiment preferably has a refractive index (n) in a range from 1.5 to 2.3 relative to the light having the wavelength in the range from 390 nm to 420 nm. Moreover, the maximum absorption wavelength of the organic dye is preferably set equal to or above 420 nm.

Next, other layers constituting the optical recording medium 100 adopting this embodiment will be described.

(First Transparent Substrate)

The first transparent substrate 101 is for instance made of a material having excellent optical characteristics including high transparency and low birefringence, and further having excellent formability in terms of injection molding and the like. Moreover, it is preferable that the first transparent substrate 101 have a low hygroscopic property. Although the material for forming the first transparent substrate 101 is not particularly limited, it is possible to use polycarbonate resin, amorphous polyolefin resin, acrylic resin or polyester resin, for example.

In the first transparent substrate 101, tracking grooves are formed either spirally or concentrically on one surface thereof. The tracking grooves may be wobbled at a constant cycle for a servo purpose, or the wobble cycle may be modulated for an address purpose. Moreover, a pit may be provided for forming management information and the like thereon. A track pitch of the tracking grooves formed on the first transparent substrate 101 is usually set in a range from 390 nm to 410 nm or preferably in a range from 395 nm to 405 nm. Meanwhile, the depth of the tracking grooves is usually set in a range from 50 nm to 90 nm or preferably in a range from 60 nm to 80 nm. The groove depth of the grooves formed on the first transparent substrate 101 is preferably set at least twice as large as the groove depth of grooves formed on the second substrate 108 to be described later.

The thickness of the first transparent substrate 101 is preferably set to about 0.6 mm. In addition, the thickness of the first transparent substrate 101 may be adjusted in conformity to the thicknesses of other layers.

The first transparent substrate 101 is preferably formed by injection molding while fabricating a master plate and a stamper. An enhancement layer and a solvent resistant layer which are made of SiO₂, ZnS—SiO₂, and the like may be provided between the first transparent substrate 101 and the first recording layer 102.

(Translucent Intermediate Layer)

The translucent intermediate layer 103 preferably has the following characteristics, namely, low absorption of the laser beam 120 incident from the first transparent substrate 101 side, optical transmittance equal to or above 30%, and, usually, appropriate optical reflectance. For instance, it is possible to maintain a balance between the appropriate optical transmittance and the appropriate optical reflectance by reducing a thickness of a metal film having a high reflectivity. Moreover, since the thickness of the translucent intermediate layer 103 is extremely small (usually in a range from about 3 nm to 5 nm), it is desirable to apply a corrosion-resistant material. In addition, the translucent intermediate 103 preferably has a certain degree of shielding property sufficient for preventing seepage of the organic dye contained in the first recording layer 102 into the transparent adhesive layer 104.

The translucent intermediate layer 103 is for instance made of gold (Au), silver (Ag), aluminum (Al) or an alloy containing any of the foregoing metals, and is formed by means of the sputtering method or the like. Among these materials, Ag is particularly suitable for a major component in light of low costs and a high reflectivity. If crystal grains of the metal constituting the translucent intermediate layer 103 are excessively large, such crystal grains causes noises in the recording and reproducing light. Accordingly, it is preferable to apply a material having small crystal grains. In addition, pure silver tends to contain relatively large crystal grains, therefore, it is preferred that Ag be used in the form of an alloy.

Among various alloys containing Ag as the major component, it is preferable to apply an alloy containing at least one element, other than Ag, which is selected from the group consisting of Ti, Zn, Cu, Pd, Au, Ca, In, and rare-earth metals in a range from 0.1 atom % to 5 atom %. When the alloy containing Ag as the major component contains two or more metals selected from Ti, Zn, Cu, Pd, Au, Ca, In, and the group of rare-earth metals, the concentration of each metal element should be adjusted to the rate from 0.1 atom % to 5 atom %, and preferably, the total of the metals should be adjusted to the rate from 0.1 atom % to 5 atom %. Among the rare-earth metals, neodymium is particularly preferred. To be more precise, AgPdCu, AgCuAu, AgCuAuNd, AgCuNd, AgCaCu, AgIn or the like can be cited.

As the material of the translucent intermediate layer 103, Au is suitable in light of small crystal grains and excellent corrosion resistance. However, Au is more costly than the Ag alloy. Alternatively, as for the translucent intermediate layer 103, by use of a material such as SiO₂ other than metals, multilayer films may be formed by laminating a thin film having a low refractive index and a thin film having a high refractive index alternately, and thereby a reflective layer having an appropriate optical transmittance can be formed.

It is also possible to provide another layer such as an enhancement layer or an anti-oxidation layer which are made of SiO₂, ZnS—SiO₂, Al₂O₃ or the like between the first recording layer 102 and the translucent intermediate layer 103. Alternatively, it is possible to form a protective layer on the translucent intermediate layer 103. In this case, the protective layer may be a layer, which is capable of only protecting the translucent intermediate layer 103, and the protective layer is made of, for instance, ultraviolet curing resin, silicone resin or the like.

(Second Substrate)

The second substrate 108 is preferably made of a material having high mechanical stability, high rigidity, and excellent formability in terms of injection molding or the like. Moreover, it is preferable that the second substrate 108 have a low hygroscopic property. It is to be noted, however, that the second substrate 108 is not required to possess the optical transmittance and the optical characteristics as the above described first transparent substrate 101 has. The material for forming the second substrate 108 may be similar materials used for the first transparent substrate 101. In addition, it is also possible to use ABS resin, filler-containing epoxy resin, an aluminum alloy substrate containing Al as a major component such as an Al—Mg alloy, and the like.

In the second substrate 108, tracking grooves are formed either spirally or concentrically on one surface thereof as similar to the first transparent substrate 101. The tracking grooves may be wobbled at a constant cycle for a servo purpose, or the wobble cycle may be modulated for an address purpose.

A track pitch of the tracking grooves formed on the second substrate 108 is usually set in a range from 390 nm to 410 nm or preferably in a range from 395 nm to 405 nm. Meanwhile, the depth of the tracking grooves is usually set in a range from 10 nm to 40 nm or preferably in a range from 15 nm to 35 nm. Moreover, a pit may be provided for forming management information and the like thereon. The second substrate 108 is preferably formed by injection molding while fabricating a master plate and a stamper. Moreover, the thickness of the second substrate 108 is preferably set to about 0.6 mm, and the thickness of the second substrate 108 may be adjusted in conformity to the thicknesses of other layers.

(Reflective Layer)

The reflective layer 107 is preferably made of a material having a high reflectivity and an excellent corrosion resistance. In order to increase the reflectivity, the thickness of the reflective layer 107 is usually set equal to or above 50 nm or preferably equal to or above 80 nm. However, it is also preferable to form the thin reflective layer 107 to some extent in order to improve recording sensitivity. Moreover, if the reflective layer 107 is excessively thick, there is a risk of warpage of the second substrate 108. Accordingly, the thickness of the reflective layer 107 is usually set equal to or below 300 nm or preferably equal to or below 200 nm.

As a material for forming the reflective layer 107, one having a sufficiently high reflectivity (such as equal to or above 60%) relative to the wavelength of the reproducing light is used. For example, as the material metals such as Al, Ag or Cr, or an alloy thereof can be cited. Among them, Al, Ag, or an alloy thereof are preferred. As components forming the alloy, metals such as Mg, Se, Hf, V, Nb, Ru, W, Mn, Re, Fe, Co, Rh, Ir, Cu, Zn, Cd, Ga, In, Si, Ge, Te, Pb, Po, Sn, Bi or rare-earth metals, or metalloids can be cited.

Among the metals described above, an Ag alloy is preferred in light of low costs, high reflectivity, and excellent corrosion resistance. It is preferred that the Ag alloy containing Ag as a major component contain at least one element selected from the group consisting of Ti, Zn, Cu, Pd, Au, Ca, In, and rare-earth metals preferably in a range from 0.1 atom % to 5 atom %. When the alloy contains two or more kinds of metal selected from the group consisting of Ti, Zn, Cu, Pd, Au, Ca, In, and rare-earth metals, the concentration of each metal should be adjusted to in a range from 0.1 atom % to 5 atom %, and preferably, the total of the metal concentrations should be adjusted to the rate from 0.1 atom % to 5 atom %. Among the rare-earth metals, neodymium is particularly preferred. To be more precise, the alloy may be AgPdCu, AgCuAu, AgCuAuNd, AgCuNd, AgCaCu, AgIn or the like.

As the method of forming the reflective layer 107, for example a sputtering method, an ion plating method, a chemical deposition method, and a vacuum deposition method can be cited. However, the sputtering method is preferred in light of productivity.

(Interface Layer)

The interface layer 105 is formed on the second recording layer 106 in order to shield the second recording layer 106 containing the organic dye against the transparent adhesive layer 104 and to prevent mixing of the two layers. Specifically, as will be described later, the interface layer 105 is provided between the both layers in order to prevent mutual dissolution between a liquid ultraviolet curing resin used as the transparent adhesive layer 104 and the second recording layer 106.

A material for forming the interface layer 105 is not particularly limited as long as the material does not mix with the second recording layer 106 and with the transparent adhesive layer 104. The interface layer 105 may have other functions, or it is also possible to interpose other layers between the second recording layer 106 and the transparent adhesive layer 104 as needed.

The material for forming the interface layer 105 is preferably an inorganics. Specifically, the material for instance includes metal, semiconductor, an oxide of metal or semiconductor, a nitride thereof, a sulfide thereof, and transparent inorganics such as a dielectric. To be more precise, it is suitable to apply any of a silicon oxide such as silicon dioxide; an oxide such as zinc oxide, cerium oxide or yttrium oxide; a sulfide such as zinc sulfide or yttrium sulfide; a nitride such as silicon nitride; silicon carbide; a mixture of an oxide and sulfur; and other alloys to be described later. Moreover, it is also suitable to apply a mixture of silicon oxide and zinc sulfide in the proportion of about 30:70 to 90:10 (by weight ratio). Alternatively, it is suitable to apply a mixture of a mixture of sulfur and yttrium dioxide, and zinc oxide (Y₂O₂S—ZnO).

The thickness of the interface layer 105 is usually set equal to or above 3 nm or preferably equal to or above 5 nm. Neverthelss, the thickness should be set equal to or below 100 nm or preferably equal to or below 50 nm. If the thickness of the interface layer 105 is too small, the shielding effect tends to be insufficient. On the contrary, if the thickness of the interface layer 105 is too large, there is a risk that the optical transmittance is deteriorated. Moreover, when the interface layer 105 is a layer made of inorganics, formation of such a film takes a long time, and there is a tendency that productivity is reduced, or a film stress is increased. As the method of forming the interface layer 105, for example, the sputtering method, the ion plating method, the chemical deposition method, and the vacuum deposition method can be cited, however the sputtering method is preferred in light of productivity.

(Transparent Adhesive Layer)

The transparent adhesive layer 104 is preferably made of a material having the following characteristics of, besides transparency in terms of the recording and reproducing wavelength, high adhesion, a small shrinkage ratio at a time of curing and adhesion, and high environment preservation stability.

The optical recording medium 100 adopting this embodiment applies focus servo separately to the two recording layers (the first recording layer 102 and the second recording layer 106). Accordingly, it is preferable to adjust the thickness of the transparent adhesive layer 104 precisely. Although it depends on a focus servo mechanism, it is necessary that the thickness of the transparent adhesive layer 104 is equal to or above 10 μm. The thickness of the transparent adhesive layer 104 may be reduced, as a trend, along an increase in the numerical aperture of an object lens used for recording and reproduction. When the optical recording medium 100 is manufactured by attaching two substrates, each having the thickness of 0.6 mm and a blue laser is used as the recording and reproducing light, the thickness of the transparent adhesive layer 104 is preferably set to about 20 μm. The transparent adhesive layer 104 is preferably made of a material which does not damage the translucent intermediate layer 103. Alternatively, it is also possible to provide a publicly-known organic or inorganic protective layer between the both layers.

For example, a material for forming the transparent adhesive layer 104 may include thermoplastic resin, thermosetting resin, electron-beam setting resin, ultraviolet curing resin (including a delayed curing type), a pressure sensitive two-sided tape, and the like. Among these materials, the ultraviolet curing resin of a non-solvent type is desirable in light of environmental friendliness and excellent productivity. Although there are various types of ultraviolet curing resins, it is possible to use any type as long as such ultraviolet curing resin is transparent.

As the ultraviolet curing resin, a radical curable type and a cationic curable type can be cited, and the both types of the ultraviolet curing resin are applicable to the present invention. All publicly-known compositions can be used as the radical curable type ultraviolet curing resin. A composition containing an ultraviolet curing compound and a photopolymerization initiator as essential components is used herein. As the ultraviolet curing compound, it is possible to use as polymeric monomer components one or a combination of two or more kinds of the following, namely, monofunctional acrylates, monofunctional methacrylates, polyfunctional acrylates, and polyfunctional methacrylates.

For example, the monofunctional acrylates and the monofunctional methacrylates may be acrylates and methacrylates which contain, as a substituent, any of methyl, ethyl, propyl, butyl, amyl, 2-ethylhexyl, octyl, cyclohexyl, benzyl, methoxyethyl, butoxyethyl, phenoxyethyl, tetrahydrofurfuryl, glycidyl, 2-hydroxyethyl, 2-hydroxypropyl, dimethylaminoethyl, nonylphenoxyethyltetrahydrofurfuryl, isobornyl, and dicyclopentanyl.

Meanwhile, the polyfunctional acrylates and the polyfunctional methacrylates may be diacrylates and dimethacrylates for instance including 1,3,-butylene glycol, 1,4-butanediol, 1,5-pentanediol, 3-methyl-1,5-pentanediol, 1,6-hexanediol, neopentyl glycol, 1,8-octanediol, ethylene glycol, polyethylene glycol, propylene glycol, dipropylene glycol, tripropylene glycol, and the like.

Moreover, it is also possible to use a polymeric oligomer together with any of the above-described polymeric monomers. For example, the polymeric oligomer may be polyester methacrylate, polyester acrylate, polyether methacrylate, polyether acrylate, epoxy methacrylate, epoxy acrylate, urethane methacrylate, urethane acrylate, and the like.

Meanwhile, any one of publicly-known photopolymerization initiators is applicable to the present invention. However, a molecular cleavage type photopolymerization initiator or a hydrogen abstraction type photopolymerization initiator is preferred. For example, the preferable molecular cleavage type photopolymerization initiator may be benzoin isobutylether, 2,4-diethylthioxanthone, 2-isopropylthioxanthone, benzyl, 2,4,6-trimethylbenzoyl-diphenyl-phosphineoxide, 2-benzyl-2-dimethylamino-1-(4-morpholinophenyl)-butane-1-on, bis(2,6-dimethoxybenzoyl)-2,4,4-trimethylpentylphosphineoxide, and the like.

For example, the molecular cleavage type photopolymerization initiator may be 1-hydroxycyclohexylphenylketone, benzoylethyl ether, benzyldimethylketal, 2-hydroxy-2-methyl-1-phenylpropane-1-on, 1-(4-isopropylphenyl)-2-hydroxy-2-methylpropane-1-on, 2-methyl-1-(4-methylthiophenyl)-2-morpholinopropane-1-on, and the like.

In addition, it is also possible to use the hydrogen abstraction type photopolymerization initiator. To be more precise, benzophenone, 4-phenylbenzophenone, isophthalophenone, 4-benzoyl-4′-methyl-diphenylsulfide, and the like can be cited.

Meanwhile, it is also possible to use a sensitizer together with the photopolymerization initiator. For example, it is possible to use any of the following amines at the same time as the sensitizer, namely, trimethylamine, methyldimethanolamine, triethanolamine, ethyl p-dimethylaminobenzoate, isoamyl p-dimethylaminobenzoate, N,N-dimethylbenzylamine, and the like.

As the cationic curable type ultraviolet curing resin, all the publicly-known compositions can be used. Although there is no particular limitation, epoxy resin containing a cationic polymerization type photoinitiator is generally cited. For example, the cationic polymerization type photoinitiator may be a sulfonium salt, an iodonium salt, a diazonium salt, and the like. The iodonium salt may be diphenyliodonium hexafluorophosphate, diphenyliodonium hexafluoroantimonate, diphenyliodonium tetrafluoroborate, bis(dodecylphenyl)iodonium hexafluoroantimonate, bis(dodecylphenyl)iodonium tetrafluoroborate, bis(dodecylphenyl)iodonium tetrakis(pentafluorophenyl)borate, 4-methylphenyl-4-(1-methylethyl)phenyliodonium hexafluoroantimonate, 4-methylphenyl-4-(1-methylethyl)phenyliodonium tetrafluoroborate, and the like.

For example, the epoxy resin may be bisphenol A-epichlorohydrin epoxy resin, alicylic epoxy resin, long-chain aliphatic epoxy resin, brominated epoxy resin, glycidyl ester epoxy resin, glycidyl ether epoxy resin, heterocyclic epoxy resin, and the like. As for the epoxy resin, it is preferable to use one with low contents of liberated free chlorine and chlorine ions in order to prevent damages on the transparent intermediate layer 103. To be more precise, the amount of chlorine is set preferably equal to or below 1% by weight or more preferably equal to or below 0.5% by weight.

The proportion of the cationic polymerization type photoinitiator relative to 100 parts by weight of the cationic curable type ultraviolet curing resin is usually set in a range from 0.1 part by weight to 20 parts by weight or preferably in a range from 0.2 part by weight to 5 parts by weight. Incidentally, it is possible to use a publicly-known photosensitizer at the same time in order to achieve more effective use of the wavelength in a near-ultraviolet region or a visible region out of the wavelength range of an ultraviolet light source. For example, the photosensitizer to be used in this case may be anthracene, phenothiazine, benzylmethylketal, benzophenone, acetophenone, and the like.

Moreover, it is also possible to blend other additives with the ultraviolet curing resin for the purpose to improve various characteristics as appropriate. For example, such other additives may include: an antioxidant such as a thermopolymerization inhibitor, hindered phenol or hindered amine; a plasticizer; a silane coupling agent such as epoxysilane, mercaptosiane, methacrylsilane or acrylsilane. These other additives, which have excellent solubility to the ultraviolet curable compound and do not block ultraviolet transmittance, are appropriately selected.

The transparent adhesive layer 104 can be formed by coating the ultraviolet curing resin and then curing the resin by irradiation of ultraviolet rays. The coating method may include the spin coating method, a screen printing, a casting method, and the like. Among them, the spin coating method is preferred. The ultraviolet curing resin preferably having a viscosity in a range from 20 mPa·s to 1000 mPa·s at a temperature in a range from 10° C. to 40° C. is preferably used, thereby coating can be formed without using a solvent.

### EXAMPLES

Now, the embodiment of the present invention will be described more in detail based on examples. It is to be noted, however, that the embodiment of the present invention will not be limited to only these examples.

### Example 1

An organic recording medium (I) including two recording layers, each containing an organic dye was prepared in accordance with the following operation. A stamper A, in which grooves were formed in a counterclockwise direction, was fitted to an injection molder and a first transparent substrate A made of polycarbonate resin was obtained by injection molding. The first transparent substrate A had a diameter of 120 mm and a thickness of 0.59 mm, and modulated wobble grooves having dimensions of a track pitch of 0.40 μm, a half-value width of 0.21 μm, and a groove depth of 70 nm were formed thereon. Meanwhile, a second substrate B made of polycarbonate resin was obtained by use of a stamper B in which grooves were formed in a clockwise direction in the same manner. The second substrate B had a diameter of 120 mm and a thickness of 0.59 mm, and modulated wobble grooves having dimensions of a track pitch of 0.40 μm, a half-value width of 0.21 μm, and a groove depth of 15 nm were formed thereon.

Next, a monomethine-azo metal complex dye solution (a tetrafluropropanol solution at the concentration of 1.0% by weight) expressed by the following chemical formula (1) was coated on the surface, on which the grooves are formed, of the first transparent substrate A by the spin coating method. Here, the above-described dye solution was percolated with a filter for removing impurities and then spin coating was performed. The extinction coefficient (k) of the optical constant of the monomethine-azo metal complex dye expressed by the chemical formula (1) is 0.2.
(Chemical Formula 1)

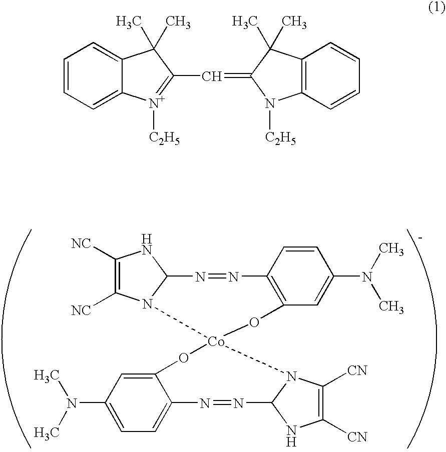

Subsequently, the first transparent substrate A coated with the above-described dye solution was dried at a temperature of 90° C. for one hour, and was then cooled down at a room temperature for one hour to form a first recording layer on the first transparent substrate A. Thereafter, by use of the sputtering method, an AgCuNd alloy serving as a translucent intermediate layer was formed on the first recording layer thus formed to have a thickness of 12 nm.

Next, an AgCuNd alloy serving as a reflective layer was formed on the surface, on which the grooves are formed, of the second transparent substrate B to have a thickness of 120 nm by use of the sputtering method. Next, a second recording layer containing the monomethine-azo metal complex dye expressed by the chemical formula (1) was formed on the reflective layer by a similar operation to formation of the first recording layer. Furthermore, ZnS—SiO₂ serving as an interface layer was formed to have a thickness of 12 nm on the second recording layer by use of the sputtering method.

Subsequently, radical polymerization type ultraviolet curing resin (UV resin) was coated on the transparent intermediate layer formed on the first transparent substrate A by use of the spin coating method, and the first transparent substrate A was placed on an attachment machine. Then, the second substrate B was placed on the attachment machine in a manner that the interface layer formed thereon faced the surface of the first transparent substrate A coated with the UV resin. Subsequently, the inner space of the machine was evacuated to prevent generation of bubbles on the UV resin layer, and the first transparent substrate A was attached to the second substrate B. Thereafter, the first transparent substrate A and the second substrate B which were attached together were taken out of the attachment machine, and UV irradiation was performed on the first transparent substrate A side to cure the UV resin layer. In this way, the optical recording medium (I) having the structure, in which the first transparent substrate A was attached to the second substrate B with the transparent adhesive layer in the thickness of 20 μm interposed therebetween, was obtained.

The optical recording medium (I) thus prepared was subjected to recording by use of a recording and reproduction evaluator having a wavelength of 405 nm and a numerical aperture of 0.65. Recording light was irradiated from the first transparent substrate A side. A concave portion on a front side of a track guide groove of the first transparent substrate A, which was viewed from the light irradiation side, was used as a recording track of the first transparent substrate A. A concave portion on a back side of a track guide groove of the second substrate B, which was viewed from the light irradiation side, was used as a recording track of the second substrate B. As for recording conditions, by an EFM signal having a frequency of 60 MHz at a line speed of 6 m/s, recording marks on the first recording layer at 12 mW and on the second recording layer at 14 mW were formed.

As a result of reproduction by use of reproducing light, a reflectivity at a portion of the recording mark formed on the first recording layer was 6.9% and a reflectivity at a portion where the recording mark was not formed was 3.8%. Meanwhile, a reflectivity at a portion of the recording mark formed on the second recording layer was 7.2% and a reflectivity at a portion where the recording mark was not formed was 3.9%. In this way, it was possible to perform the Low to High recording successfully in the first and the second recording layers. In addition, a reproduced signal based on the recording marks formed on the first recording layer showed jitters of 7.5%, while a reproduced signal based on the recording marks formed on the second recording layer showed jitters of 7.8%. Therefore, favorable eye patterns were observed in both of the recording layers.

### Example 2

An optical recording medium (II) including two recording layers, each containing an organic dye was prepared in accordance with the similar operation to Example 1 except for setting the groove depth of the second substrate B to 25 nm.

Next, as similar to Example 1, recording marks were formed on the first recording layer at 12 mW and on the second layer at 14 mW by using the concave portion on the front side of the track guide groove of the first transparent substrate A as the recording track of the first transparent substrate A while using the concave portion on the back side of the track guide groove of the second substrate B as the recording track of the second substrate B.

As a result of reproduction by use of the reproducing light, a reflectivity at a portion of the recording mark formed on the first recording layer was 6.9% and a reflectivity at a portion where the recording mark was not formed was 3.8%. Meanwhile, a reflectivity at a portion of the recording mark formed on the second recording layer was 6.8% and a reflectivity at a portion where the recording mark was not formed was 3.7%. A reproduced signal based on the recording marks formed on the first recording layer showed jitters of 7.5%, while a reproduced signal based on the recording marks formed on the second recording layer showed jitters of 7.6%. Therefore, favorable eye patterns were observed in both of the recording layers.

### Comparative Example

An optical recording medium (III) including two recording layers, each containing an organic dye was prepared in accordance with the similar operation to Example 1 except for using an organic dye expressed by the following chemical formula (2) as the organic dye contained in the recording layers. It should be noted that the extinction coefficient (k) of the optical constant of the organic dye expressed by the chemical formula (2) is 0.08.
(Chemical formula 2)

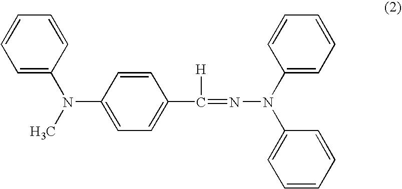

Next, as similar to Example 1, recording marks were formed on the first recording layer and on the second layer at 15 mW which was the maximum power of a recording and reproduction machine by using the concave portion on the front side of the track guide groove of the first transparent substrate A as the recording track of the first transparent substrate A while using the concave portion on the back side of the track guide groove of the second substrate B as the recording track of the second substrate B.

As a result of reproduction by use of the reproducing light, a reflectivity at a portion of the recording mark formed on the first recording layer was 5.5% and a reflectivity at a portion where the recording mark was not formed was 7.6%. Meanwhile, a reflectivity at a portion of the recording mark formed on the second recording layer was 5.7% and a reflectivity at a portion where the recording mark was not formed was 7.8%. Therefore, the polarities of the recorded signals obtained from the first and the second recording layers represent the High to Low recording, in which a reflectivity at a recorded portion became lower than a reflectivity at an unrecorded portion. Moreover, asymmetry of the signal became negative and this phenomenon clearly showed insufficient recording power. As a result, it was not possible to measure any jitter.

As described above, in the optical recording medium including two recording layers, in which information is recorded by irradiation of a blue laser from one side, and each of which has an organic dye, it is possible to achieve a two-layered optical recording medium having excellent recording sensitivity by carrying out the Low to High recording, in which a reflectivity (R₁) at a portion of a recording mark formed on a recording layer is higher than a reflectivity (R₀) at a portion where a recording mark is not formed (R₁>R₀).

Moreover, the optical recording medium has a structure including a first disk substrate formed by laminating a first recording layer and a translucent intermediate layer sequentially on a light-transmissive first substrate provided with grooves, and a second disk substrate formed by laminating a reflective layer, a second recording layer, and an interface layer sequentially on a second substrate. In addition, the first disk substrate is attached to the second disk substrate with a transparent adhesive layer interposed therebetween in a manner that the translucent intermediate layer faces the interface layer. In this way, it is possible to manufacture the optical recording medium at low costs.

What is claimed is:

1. An optical recording medium, comprising:
at least two recording layers, each of which contains an organic dye, and in which information can be recorded and reproduced by light irradiation,
wherein a reflectivity (R₁) at a portion of a recording mark formed on any of the recording layers is higher than a reflectivity (R₀) at a portion on the recording layer where the recording mark is not formed (R₁>R₀).

2. The optical recording medium according to claim 1,
wherein a difference (R₁−R₀) between the reflectivity (R₁) at the portion of the recording mark and the reflectivity (R₀) at the portion where the recording mark is not formed is set equal to or above 2%.

3. The optical recording medium according to claim 1,
wherein the organic dye has an extinction coefficient (k) equal to or above 0.1 relative to light having a wavelength in a range from 390 nm to 420 nm.

4. The optical recording medium according to claim 1,
wherein a degree of modulation of a reproduced signal obtained from the recording marks is equal to or above 40%.

5. The optical recording medium according to claim 1,
wherein the light is irradiated from one side of the optical recording medium.

6. An optical recording medium including two recording layers, each of which contains an organic dye, comprising:
a first disk substrate formed by sequentially laminating a first recording layer and a translucent intermediate layer on a first substrate made of a light-transmissive material; and
a second disk substrate formed by laminating a reflective layer, a second recording layer, and an interface layer on a second substrate,
wherein the first and the second disk substrates are laminated with a transparent adhesive layer interposed therebetween in a manner that the translucent intermediate layer faces the interface layer, and
wherein a reflectivity (R₁) at a portion of a recording mark formed on any of the first and the second recording layers by light irradiated is higher than a reflectivity (R₀) at a portion on the recording layer where the recording mark is not formed (R₁>R₀).

7. The optical recording medium according to claim 6,
wherein a groove depth of a groove formed on the first substrate preferably has a dimension at least twice as large as a groove depth of a groove formed on the second substrate.

8. The optical recording medium according to claim 6,
wherein a track pitch of the grooves formed on the first substrate and the second substrate is set in a range from 390 nm to 410 nm.

9. The optical recording medium according to claim 6,
wherein the light is irradiated from the first substrate side.

10. The optical recording medium according to claim 6,
wherein the recording marks are formed at a portion on the first recording layer existing at a concave portion on a front side of the first substrate and at a portion on the second recording layer existing at a concave portion on a back side of the second substrate when viewed from the first substrate side, on which the light is irradiated.

11. The optical recording medium according to claim 6,
wherein the light has a wavelength in a range from 390 nm to 420 nm.

12. The optical recording medium according to claim 6,
wherein the organic dye is a monomethine-azo metal complex dye.
